(19) United States
(12) Patent Application Publication
(10) Pub. No.: US 2025/0253570 A1
(43) Pub. Date: Aug. 7, 2025

(54) Female Connector Terminal Having a Cross-Section with at Least Five Sides

(71) Applicant: TE Connectivity Solutions GmbH, Schaffhausen (CH)

(72) Inventors: Daniel ROSAN, Schaffhausen (CH); Willi DIETRICH, Schaffhausen (CH); Ulrich LECHLER, Schaffhausen (CH); Nico MAIER, Schaffhausen (CH)

(73) Assignee: TE Connectivity Solutions GmbH, Schaffhausen (CH)

(21) Appl. No.: 19/040,917

(22) Filed: Jan. 30, 2025

(30) Foreign Application Priority Data
Feb. 2, 2024 (DE) 102024103035.6

(51) Int. Cl. H01R 13/187

(52) U.S. Cl. CPC H01R 13/187

(57) ABSTRACT

A connector clamp socket which fulfils high requirements for mechanical and electrical safety and has a protection against misconnection. The connector clamp socket is designed to be inserted into an electrical component in an assembly direction and comprises a plug contact receptacle and at least one insertion opening. The plug contact receptacle is designed to receive a plug contact, which penetrates through the insertion opening into the plug contact receptacle along an insertion direction. A cross-section of the connector clamp socket has a non-rotationally symmetric shape that, at least section-wise, is concave and polygonal with at least five apexes and two long sides that are opposite one another with respect to the plug contact receptacle.

### CROSS REFERENCE TO RELATED APPLICATIONS

This application claims priority to and the benefit of German Patent Application No. 102024103035.6 filed Feb. 2, 2024, which is hereby incorporated by reference in its entirety.

### BACKGROUND OF THE INVENTION

The present invention relates to a connector clamp socket for an electrical plug connection.

A connector clamp socket is used, for example, in a female plug to accept a plug contact from a male mating plug and make electrical contact with it.

When assembling such a plug, it must be ensured from the manufacturer's side that the components are assembled in the correct orientation to guarantee the intended function. To guarantee the correct orientation of the components during assembly, they often have a protection against misconnection or a polarization. Such protection against misconnection must be configured such that it does not harm the user, for example by pricking or cutting him; it must be robust in order to prevent faulty assembly even when a high force is applied, and it should not weaken the components mechanically, but rather provide additional mechanical advantages such as easier assembly and/or improved security.

### SUMMARY OF THE INVENTION

The underlying problem for the invention is to provide a connector terminal with a protection against misconnection that fulfills these requirements.

This problem is solved by means of a connector clamp socket which is configured to be inserted into an electrical component in an assembly direction, wherein the connector clamp socket comprises a plug contact receptacle and at least one insertion opening; wherein the plug contact receptacle is configured to receive a plug contact, in particular a flat plug contact, which penetrates through the insertion opening into the plug contact receptacle along an insertion direction; wherein a cross-section of the connector clamp socket has, at least sectionally, an irregular, concave polygonal shape with at least five apexes; and wherein the cross-section has two long sides that are opposite one another with respect to the plug contact receptacle.

The irregular polygonal shape prevents misconnections. The at least pentagonal polygonal shape allows for better use of space when using O-rings compared to conventional connector clamp sockets with a rectangular cross-section, since an at least pentagonal cross-section nestles better into the circular area than a rectangular cross-section. At the same time, the cross-sectional shape offers a higher mechanical load capacity and improved guidance when inserting the connector clamp socket.

The invention can be further improved by the following developments, which are each preferred, independent of each other and can be combined with each other as desired.

The polygonal shape is, in particular, a non-rotationally symmetric polygon in which the two long sides are preferably the longest sides of the polygonal cross-section. The lack of rotational symmetry causes a simple polarization. In one configuration, the long sides are the same length. Irrespective of this, they can run parallel to one another.

In its simplest configuration, the polygon shape is in particular pentagonal or hexagonal. The polygon shape can in particular be concave overall and not only section-wise.

The cross-section can be an outer cross-section of the connector clamp socket or an inner cross-section of the connector clamp socket, that is, it can form the outer contour or the inner contour of the connector clamp socket. In a particularly preferred configuration, both the outer cross-section of the connector clamp socket and the inner cross-section of the connector clamp socket, that is, the inner contour of the plug contact receptacle, can be formed by the at least pentagonal, at least section-wise concave polygonal shape.

If the at least section-wise concave, at least pentagonal cross-section of the connector clamp socket is an external cross-section or an external contour, then this is preferably configured such that it can be inscribed in a circle and/or, in particular, an elongated rectangle. “Inscribable” means in this context that all apexes of the cross-section are points on that contour in which the cross-section is inscribed, and that all sides lie within this contour. The apexes may be folded or rounded. The term “apex” is used here as a synonym for a corner of the polygonal cross-section, wherein the corner may be chamfered, for example folded, or rounded, for example, bent.

At least one of the two long sides runs parallel to the insertion direction, so that the plug contact is guided through the long side. Both long sides preferably run parallel to the insertion direction.

The connector clamp socket may have an insertion opening that is perpendicular to one, preferably both long sides of the polygonal cross-section.

The at least one insertion opening is preferably rectangular and, in particular, elongated rectangular perpendicular to the insertion direction, if the plug contact is a flat plug contact, the cross-section of which is also elongated perpendicular to the insertion direction, preferably also elongated rectangular. The inner contour of the insertion opening should be configured to be complementary to the outer contour of the cross-section transverse to the insertion direction of the plug contact, so that protection against misconnection is provided here as well.

The insertion direction in one configuration is perpendicular to the insertion opening assigned to this insertion direction. If the connector clamp socket comprises several insertion openings, each of these insertion openings is assigned to a different insertion direction. In particular, the insertion directions of different insertion openings can be perpendicular to one another. In such a configuration, the insertion opening can be perpendicular to at least one of the long sides.

In a preferred configuration, the insertion opening is perpendicular to the at least pentagonal, at least section-wise concave cross-section. To obtain the greatest possible insertion depth, the insertion opening is located on a narrow side of the cross-section.

A further configuration may provide that the number of the apexes of the cross-section beyond one end of the long sides of the cross-section is greater than beyond the other end of these long sides. For example, in the case of a pentagonal cross-section, at least three apexes of the polygonal cross-section may be adjacent to one end of the long sides, while there are only two apexes at the other end of the long sides, in particular in the insertion direction.

A greater insertion depth for the plug contact can also be achieved if the insertion opening is located along the insertion direction opposite an apex of a concave section of the polygonal cross-section. This apex can be located in the insertion direction opposite the insertion opening, in particular opposite a longitudinal center line of the insertion opening. The insertion opening can be located on the side of those ends of the long sides where the smaller number of apexes is present.

The insertion opening or the plane defined by the insertion opening can be parallel or perpendicular to the polygonal cross-section.

The connector clamp socket can have one or two insertion openings. If there are two insertion openings, these can be arranged at 90° to each other.

In one configuration, the connector clamp socket comprises a leaf spring which protrudes into the plug contact receptacle and is configured to generate a spring force acting perpendicular to the insertion direction. The spring force acts on a plug contact located in the plug contact receptacle. It serves to achieve a firm mechanical and thus firm electrical contact with the plug contact.

The leaf spring can be a one-piece or, equivalently, monolithic component of the connector clamp socket. The leaf spring can, for example, be formed by a tab or tongue.

In one configuration, the connector clamp socket is formed by a single body, which, for example, can be a stamped and bent part made from a sheet metal. The stamped and bent part can be bent around the plug contact receptacle. The stamped and bent part can have overlapping ends that are arranged on one of the long sides of the polygonal cross-section.

The connector clamp socket can be used for direct electrical and mechanical contacting of the plug contact. In such a configuration, the connector clamp socket has a section that extends beyond the plug contact receptacle and is configured to be connected to an electrical conductor. Such a section can, for example, be configured as a crimping section that can be crimped around a cable strand, or can be configured as a soldering or welding lug. However, such a section can also be configured in the form of a pin and, for example, can form a plug contact that can be inserted into a printed circuit board or a female contact of a mating plug.

In another configuration, the connector clamp socket comprises a lamella insertion opening, wherein the plug contact receptacle is configured to receive both a contact lamella extending through the lamella insertion opening in a lamella insertion direction into the plug contact receptacle and a plug contact extending through the insertion opening in the insertion direction into the flat contact receptacle. In such a configuration, the connector clamp socket is used to establish a mechanical and electrical contact between the contact lamella and the plug contact. For example, the contact spring mentioned above can be used in such a configuration to press the plug contact and the contact lamella against each other. Outside the connector clamp socket, the contact lamella can form a crimp section for attachment to a cable strand, a welding or soldering lug, or a plug contact.

The connector clamp socket may have devices that serve to fasten it to the contact lamella. For example, there may be clamping tongues that can be bent around the contact lamella. The contact lamella may have recesses complementary to the clamping tongues, which enable a form fit with the clamping tongues.

The connector clamp socket can be part of an arrangement that also includes an electrical component such as a printed circuit board (PCB), an electrical plug and/or an electrical component. In such an arrangement, the connector clamp socket is attached to the electrical component. For example, the connector clamp socket can be inserted into the electrical component and held in the electrical component in a form-fitting manner, for example, by interlocking latching protrusions and latching recesses on the electrical component and the connector clamp socket.

The electrical component may, however, also have the above-mentioned contact lamella that extends into the plug contact receptacle of the connector clamp socket. The connector clamp socket may be attached to the electrical contact lamella.

The electrical component may have a contact chamber into which the connector clamp socket is inserted in one assembly direction.

In this case, the contact lamella can extend in the assembly direction into the flat contact receptacle. In such a configuration, the assembly direction is parallel to the lamella insertion direction.

The lamella insertion opening or the plane spanned by it can run perpendicular to the at least one insertion opening of the plug contact or the plane spanned by the insertion opening. Furthermore, the lamella insertion opening can extend perpendicular to the assembly direction. In one configuration, the polygonal cross-section of the connector clamp socket is transverse, perpendicular to the assembly direction. This has the advantage that the polygonal cross-section can simultaneously form protection against misconnection. The polygonal cross-section of the connector clamp socket can also extend parallel to the assembly direction.

In one configuration, the polygonal cross-section can extend over the entire depth of the connector clamp socket in the assembly direction, but at least over the width of the insertion opening transverse to the polygonal cross-section and/or at least over the width of the plug contact receptacle transverse to the polygonal cross-section. These measures ensure that the polygonal cross-section is present over the entire width, in particular of a flat plug contact.

The long sides of the at least pentagonal cross-section are preferably formed by planar, in particular rectangular, flat sides of the connector clamp socket, wherein the flat sides can have form-fit elements for fastening to the electrical component as well as one or more stops. The flat sides extend along the assembly direction and the at least one insertion direction. The sides of the connector clamp socket that form the narrow sides of the pentagonal cross-section can also be formed by rectangular, in particular elongated, surfaces that preferably extend along the assembly direction and either transversely or longitudinally to an insertion direction.

In a further configuration, the assembly direction can be anti-parallel or perpendicular to the insertion direction of the plug contact.

The connector clamp socket in one of the above configurations can be part of an electrical connection that also includes the above arrangement. The electrical connection in such a configuration has a flat plug contact inserted into the connector clamp arrangement in the insertion direction through the insertion opening.

In this case, one end of the flat plug pointing in the insertion direction can be at least at the same level as an end of a long side of the cross-section pointing in the insertion direction. A particularly large insertion depth can be achieved if a center plane of the flat plug contact, the center plane being located halfway through the material thickness of the flat plug contact, is located opposite an apex of the polygonal cross-section in the insertion direction. In this case, the material thickness of the flat plug contact should be less than half the height of the receptacle in the direction of the material thickness. The material thickness of the contact lamella can be approximately the same as the material thickness of the flat plug contact or, more generally, the plug contact.

In the following, the invention is exemplarily described in more detail by means of embodiments with reference to the attached Figures. In doing so, for the sake of simplicity, the same reference signs are used in the Figures for elements that correspond to each other in terms of structure and/or function.

In accordance with the above, a feature of an embodiment described below can be omitted at any time, provided that the technical effect associated with that feature is irrelevant to the implementation of the embodiment. Conversely, in accordance with the above, a feature described above can be added to an embodiment described below, provided that the technical effect associated with that feature is relevant to a particular implementation.

### BRIEF DESCRIPTION OF THE DRAWINGS

FIG. 1 a schematic perspective view of a contact arrangement with a connector clamp socket;

FIG. 2 a schematic sectional view of the arrangement of FIG. 1;

FIG. 3 a schematic cross-sectional view of the arrangement of FIG. 1 with a plug contact;

FIG. 4 a schematic perspective view of a further arrangement;

FIG. 5 a schematic perspective view of a further arrangement;

FIG. 6 a schematic side view of a plug with an arrangement according to one of FIGS. 1-5;

FIG. 7 a schematic view of a cross-section of a connector clamp socket;

FIG. 8 a schematic view of a further cross-section of a connector clamp socket; and

FIG. 9 a further schematic view of a cross-section of a connector clamp socket.

The accompanying drawings, which are incorporated into and form a part of the specification, schematically illustrate one or more exemplary embodiments of the invention and, together with the general description given above and detailed description given below, serve to explain the principles of the invention.

### DETAILED DESCRIPTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. In various applications, relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features, the scope of the invention being defined by the claims appended hereto.

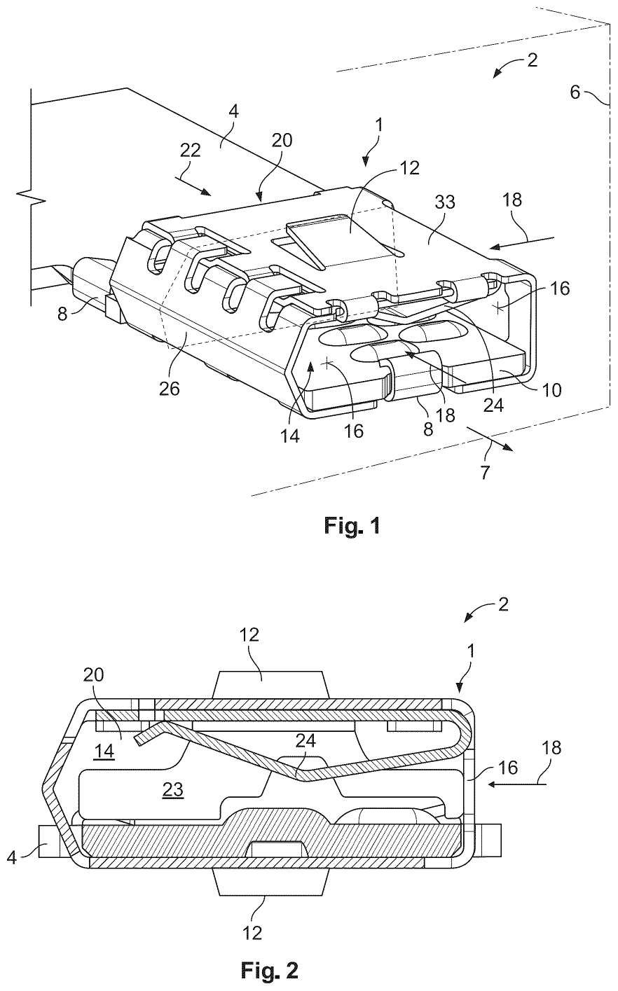

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention. First, an embodiment of a connector clamp socket 1 is described with reference to FIGS. 1 and 2.

In FIG. 1, for example, the connector clamp socket 1 is part of an arrangement 2 that also comprises a contact lamella 4. The contact lamella 4 can be part of an electrical component 6, for example a plug, a printed circuit board (PCB) or an electrical device such as a sensor or an actuator, which is merely indicated in FIG. 1. The connector clamp socket 1 is preferably configured to be inserted in an assembly direction 7 into the electrical component 6 and in particular to be fully received there.

The connector clamp socket 1 is preferably made of a metal sheet and is, for example, a stamped and bent part. As shown, the connector clamp socket 1 can be attached on the contact lamella 4. Thus, the connector clamp socket 1 can have clamping elements 8 that clamp the contact lamella 4 by, for example, grasping an edge 10.

The connector clamp socket 1 can be configured to be received in a contact chamber (not shown) of the electrical component 6. In order to be able to fasten the connector clamp socket 1 in such a contact chamber, one or more latching elements 12, for example in the form of latching tongues or, equivalently, latching lugs, can be provided. The connector clamp socket 1 can also have stops in the form of projections. With such stops, the connector clamp socket 1 can be precisely positioned in a contact chamber.

The connector clamp socket 1 comprises a plug contact receptacle 14 that is configured to receive a plug contact as described below. The plug contact receptacle is essentially a cavity. The plug contact can be configured as a pin or as a flat contact. Accordingly, the plug contact receptacle 14 is then configured as a plug contact receptacle or as a flat contact receptacle.

Furthermore, the connector clamp socket 1 has one or two insertion openings 16 through which a flat contact can be inserted into the plug contact receptacle 14 along an insertion direction 18. The inner contour transverse to the insertion direction 18 of an insertion opening 16 is, in one configuration, complementary to the outer contour transverse to the insertion direction of the plug contact that is intended to be used with this insertion opening 16.

If, as shown in FIG. 1, two insertion openings 16 are present, then these, or equivalently the planes spanned by them, can be aligned perpendicular to one another. The insertion direction 18 is preferably perpendicular to the associated insertion opening 16.

The contact lamella 4 protrudes through a lamella insertion opening 20 along a lamella insertion direction 22 into the plug contact receptacle 14. In the embodiment of FIG. 1, the plug contact receptacle 14 is configured to receive both the contact lamella 4 and the plug contact. The lamella insertion direction 22 can run parallel or transverse to the assembly direction 7.

The lamella insertion direction 22 can run anti-parallel or transverse to the insertion direction 18 of the plug contact, depending on whether the connector clamp socket is used as a 180° or 90° connection. If two insertion openings 16 are present, the lamella insertion direction 22 preferably runs anti-parallel to the insertion direction 18 directed through the one insertion opening 16 and transverse to the insertion direction 18 directed through the other insertion opening 16.

Of course, a contact lamella 4 can be dispensed with if an appropriate other electrical connection is provided. For example, the connector clamp socket 1 itself can take over the function of the contact lamella 4. For example, the connector clamp socket 1 can be configured as a cable lug or inserted into a larger socket made of conductive material.

The connector clamp socket 1 can have a wall section 23 on the lamella insertion opening 20, which partially closes this side running transverse to the lamella insertion direction 22. Due to the wall section 23, the lamella insertion opening 20 has a contour that is complementary in particular only to the contact lamella 4, but not to the plug contact, so that misconnections can be avoided.

The connector clamp socket 1 can also have a contact spring 24 that protrudes into the plug contact receptacle 14.

The opening present in FIG. 1 in lamella insertion direction 22, which is designated as insertion opening 16, can be omitted in a variant. The connector clamp socket 4 thus serves as an angled plug. For this purpose, this opening does not have to be closed, but can remain open. For example, the connector clamp socket 1 can be arranged in the electrical component 6 in such a way that an insertion opening is not accessible. Alternatively or cumulatively, the contact spring 24 can be configured to only allow the plug contact to be inserted through an opening of the connector clamp socket 1.

A cross-section 26 of the connector clamp socket 1 is polygonal and at least pentagonal. In particular, the cross-section is a concave, irregular polygon that, in particular, cannot be rotationally symmetrical.

The cross-section 26 can be an outer cross-section, that is, the cross-section of the outer contour of the connector clamp socket 1, or a cross-section, that is, the inner contour of the connector clamp socket 1 or the outer contour of the plug contact receptacle 14. Both the inner and outer contours of the connector clamp socket 1 are preferably polygonal, wherein the contact spring 24 remains unconsidered.

In the embodiment shown, the cross-section 26 is perpendicular to the lamella insertion direction 22 and/or either perpendicular or parallel to an insertion direction 18. At least one insertion opening 16 can be perpendicular or parallel to the at least pentagonal cross-section. The sides of the cross-section 26 are formed by a configuration of preferably flat and/or preferably rectangular surfaces that run perpendicular to the cross-section 26.

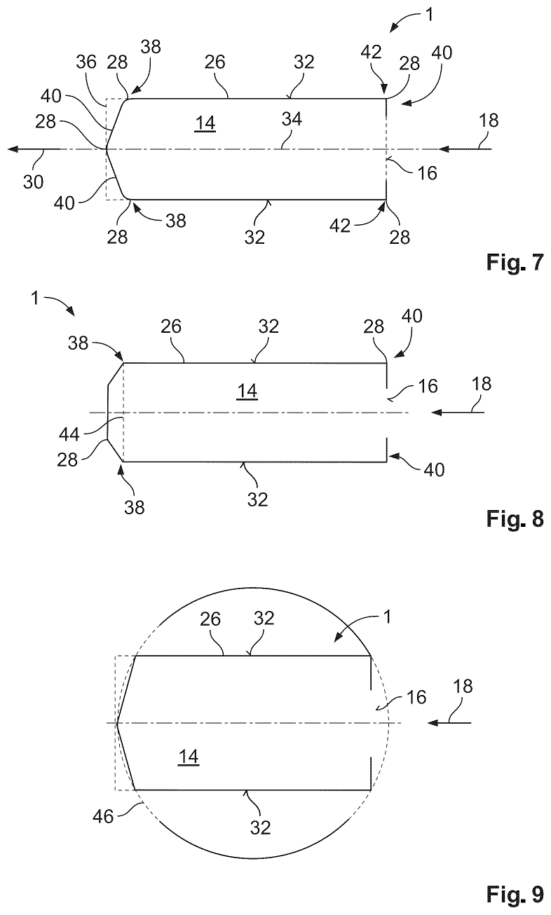

The geometry of the cross-section 26 is described in more detail below with reference to FIGS. 7 to 9. For the sake of brevity, only the differences to the preceding embodiments are discussed.

FIG. 7 shows, in conformity with the configuration of FIGS. 1 and 2, that the polygonal cross-section 26 may be pentagonal, thus having five apexes 28. An apex 28 of the polygonal cross-section can be formed by a folded or bent corner. The polygonal cross-section 26 is elongated in a longitudinal direction 30. The longitudinal direction 30 can run parallel to an insertion direction 18.

Two longitudinal sides 32 extending in the longitudinal direction 30 lie opposite each other with respect to the plug contact receptacle 14. The two long sides 32 can run parallel to one another, but do not have to. In a preferred configuration, the two long sides 32 are the same length. The insertion direction 18 of at least one insertion opening 16 extends parallel to at least one, preferably both, long sides 32. The long sides 30 of the cross-section 26 are formed by flat sides 33 of the connector clamp socket 1, which extend parallel to the lamella insertion direction 22. At least one, preferably both flat sides 33 can run perpendicular to at least one, preferably both insertion openings 16.

In the insertion direction 18, the insertion opening 16 is located opposite an apex 28. In particular, the apex 28 opposite the insertion opening 16 can be aligned with a center plane 34 of the insertion opening 16. In one configuration, the center plane 34 runs parallel to at least one long side 32 or parallel to the cross-section 26. The cross-section 26 can preferably be inscribed in an elongated rectangle.

In the variant of FIG. 7, the long sides 32 extend away from the insertion opening 16. At the end 38 of the long sides 32 pointing away from the insertion opening 16, the cross-section 26 has more apexes 28 or more narrow sides 38 than at the end 42 facing the insertion opening 16.

Thus, in the pentagonal cross-section 26 shown in FIG. 7, there are three apexes 38 or two narrow sides 40 on the side of the ends 38, whereas there are two apexes 28 or one narrow side 40 at the other opposite end 42. The insertion opening 16 is formed by one narrow side 40, which directly connects the two long sides 32.

The irregular polygonal cross-section 26, when it forms the outer contour of the connector clamp socket 1, together with an inner contour complementary to this outer contour of a contact chamber receiving the connector clamp socket 1, forms a protection against misconnection, since it can only be inserted into the contact chamber in one orientation. This is achieved, for example, by the fact that there are differently shaped narrow sides 38 at both ends 38, 42.

As shown in FIG. 8, the cross-section 26 does not have to be pentagonal; it can also have six or more apexes 28, that is, it can be at least hexagonal. Here, too, there can be more apexes 28 on the side of the ends 38 of the long sides 32 facing away from the insertion opening 16 than on the side of the other ends 40 of the long sides 32.

As will be explained below, it is advantageous if at least one apex 28 is located on the side of the ends 38 outside the area in which the long sides 32 overlap. In other words, at least one narrow side of the polygonal cross-section is concave. At least one apex 28 should therefore, when viewed from the insertion opening in the insertion direction 18, be located beyond a line 44 connecting the ends 38 of the long sides 32. This increases the depth of the plug contact receptacle 14, which has at least a pentagonal cross-section in the insertion direction 18, compared to a plug contact receptacle 14 with a rectangular cross-section, which would be bounded by the line 44 opposite the insertion opening 16.

In a further configuration, as is exemplarily shown in FIG. 9, the cross-section 26 can be inscribed in a circle 46. The circle 46 may correspond to a cable diameter or to the diameter of a sealing ring. Due to the at least pentagonal cross-section, a larger part of the predetermined circle diameter can be used for the insertion depth of the plug contact, which is only exemplarily configured as a flat contact 52 here.

FIG. 3 shows an electrical connection 50 that includes the arrangement 2 or the connector clamp socket 1 and, in addition, a flat contact 52. The flat contact 52 can be repeatedly inserted into the connector clamp socket 1. This distinguishes it from the contact lamella 4, which-if present—is firmly connected to the connector clamp socket 1.

In FIG. 3, the flat contact 52 is shown in the connector clamp socket 1 in the fully inserted state. Such complete insertion of the flat contact 52 into the connector clamp socket 1 occurs automatically when the plugs (not shown in FIG. 3), which comprise the connector clamp socket 1 and the flat contact 52, are fully inserted into each other.

Due to the flat contact 52, the contact spring 24 is deflected and, due to the deflection of the contact spring 24, a contact force 54 is generated which presses the flat contact 52 against the contact lamella 4. The contact force 54 ensures a mechanical contact and thus an electrically conductive transition between the contact lamella 4 and the flat contact 52. In one configuration without a contact lamella 4, the flat contact 52 can be pressed against the connector clamp socket 1 by the contact spring 24 in the fully inserted state.

In the insertion direction 18, the flat contact 52 overlaps or covers the apex 28 opposite the insertion opening 16 in the insertion direction 18. When the flat contact 52 is fully inserted into the plug contact receptacle 14, its end 56 that is located in the insertion direction 18 is at least level with one end 38 of one long side 32 of the cross-section 26, or even extends beyond the ends 38. At the same time, the end 56 of the section of the connector clamp socket 1 opposite it in the insertion direction 18 is slightly spaced apart. Such a distance is necessary for safety reasons to compensate for tolerances in series production. Despite the safety distance, the flat contact 52 can be inserted deeper into the connector clamp socket with a pentagonal cross-section 26 than into a connector terminal 1 with a rectangular cross-section.

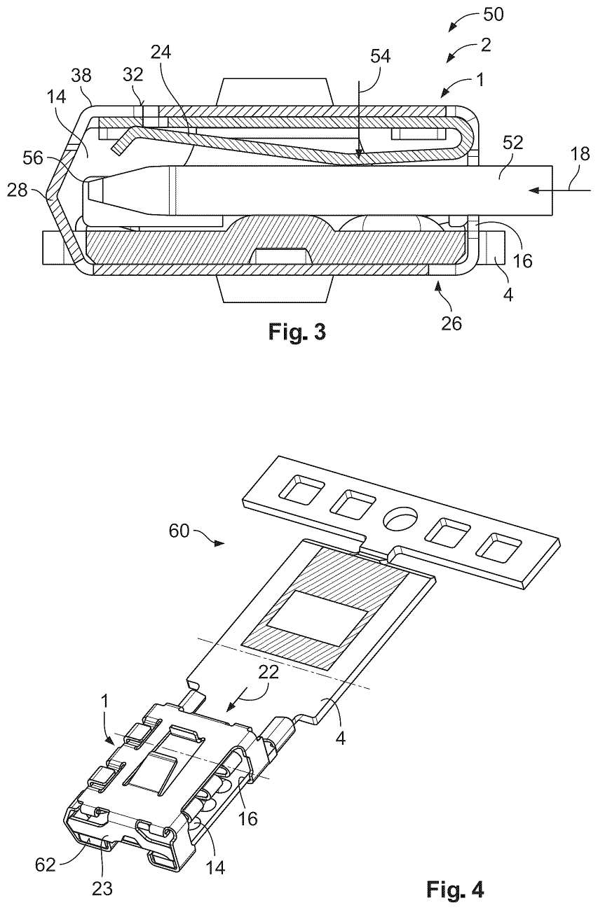

FIG. 4 shows that the connector clamp socket 1 can already be assembled on the contact lamella 4 when it is still part of a contact strip 60. Moreover, FIG. 4 shows a variant of the connector clamp socket 1 with only one insertion opening 16, compared to the variant of FIGS. 1 and 2 with two insertion openings 16. The side 62 pointing away from the lamella insertion direction 22 is closed here by a wall section 23. In this case, the wall section 23 can have an identical shape on the two sides of the connector clamp socket 1, with respect to the lamella insertion direction 22, so that the contact lamella 4 can be inserted from both sides into the contact receptacle 14 past the wall sections 23 into the contact receptacle 14.

In the embodiments of FIGS. 1 to 4 and 7 to 9, in one variant, the at least pentagonal cross-section 26 or an at least pentagonal inner contour of the connector clamp socket 1 is provided along the assembly direction 7 and/or transverse to the insertion direction 18 and parallel to the insertion opening 16 at least over the width of the insertion opening 16 in this direction and/or at least over the width of the flat contact 52 in this direction. Alternatively or cumulatively, the same cross-section 26 or the same outer contour is provided over the entire depth of the connector clamp socket 1 in the assembly direction 7. Furthermore, for manufacturing reasons, it is preferred if the cross-section 26 remains constant in the normal direction and does not change its shape.

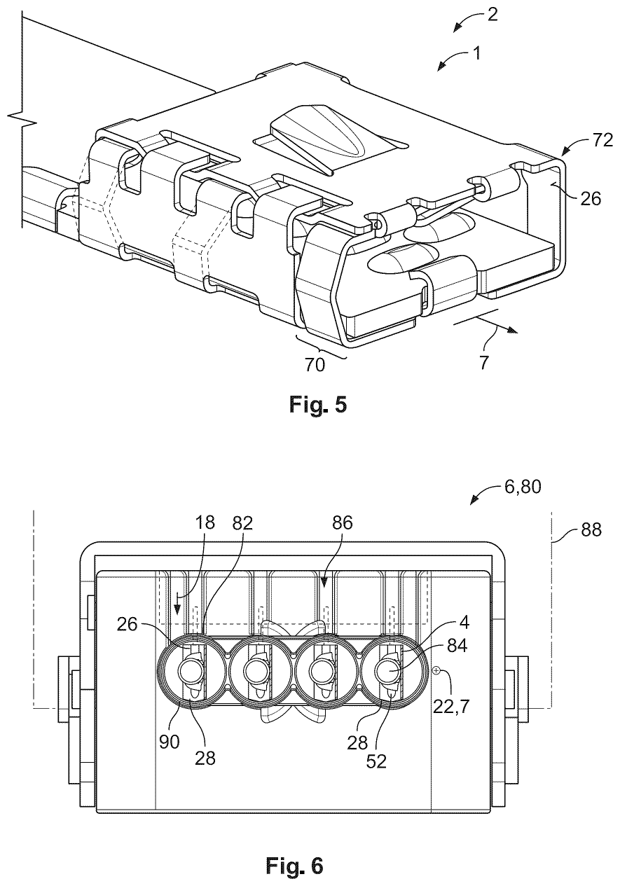

If the only requirement is to provide protection against misconnection rather than an increased insertion depth for a flat contact 52, then the configuration of FIG. 5 can be considered, in which an at least pentagonal, polygonal cross-section, as described above with reference to FIGS. 7 to 9, is not present over the entire width of the flat contact 52 or the entire depth of the connector clamp socket 1 in the assembly direction 7. Rather, only a section 70 of the connector clamp socket 1 that extends along the assembly direction 7 has an irregular and, in particular, concave cross-section that is at least pentagonal, while the rest of the cross-section 26 is, for example, rectangular or otherwise polygonal.

The section 70 with the at least pentagonal cross-section 26 is preferably located at the (front) end 72 of the connector clamp socket 1 pointing in the assembly direction 7 and thus prevents the connector clamp socket 1 from being inserted incorrectly into a contact chamber or into a contact chamber that is not configured to be complementary to the cross-section of the section 70.

Instead of only one at least pentagonal section 70, there may also be two or more sections 70 spaced apart in the assembly direction 7. Further sections 79 are shown in FIG. 5 in dashed lines.

As long as the rear sections 70 in the assembly direction 7, for example pointing to the contact lamella 4 in FIG. 5, have a polygon shape that can be inscribed in the polygon shape of the respective front sections 70, the sections 70 do not have to have the same cross-section, although this is preferred for manufacturing reasons.

FIG. 6 shows an electrical component 6 in the form of a plug 80. The plug 80 has at least one contact chamber 82, here, for example purposes only, four contact chambers 82, in which a connector clamp socket 1 is inserted in the assembly direction 7. The contact lamella 4 is connected to an electrical conductor 84, for example a cable strand, wherein in this example the lamella insertion direction 22 corresponds to the assembly direction 7. The connector clamp socket 1 is configured as described above in FIGS. 1 to 5 and 7 to 9.

The plug 80 has a plug face 82, with which a mating plug 88, which is only shown schematically, can be plugged together. The plug contacts are flat contacts 52 and part of the mating plug 88. The flat contacts 52 are inserted in the insertion direction 18 into the connector clamp socket 1 so that they are electrically conductively connected to the respective contact lamella 4 of the connector clamp socket 1.

In order to seal the contact chambers and the connector clamp sockets 1 located therein from the outside, ring seals can be used which can be inserted into correspondingly annular seal receptacles 90 of the plug 80, wherein each seal receptacle 90 can be assigned to a contact chamber 82 and seal the same.

The at least pentagonal cross-section 26 lies in a plane parallel to the plane of the seal receptacle 90 and within the seal receptacle 90. Due to the flat contact 52 in the insertion direction 18, the opposite apex 28 allows for a greater insertion depth despite a safety distance between the flat contact 52 and the connector clamp socket 1, as already explained in FIG. 3 above. At the same time, the irregular, non-rotationally symmetrical, polygonal cross-section ensures that the connector clamp socket 1 can only be inserted into a contact chamber 82 in one position.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

What is claimed:

1. A connector clamp socket which is configured to be inserted into an electrical component in an assembly direction, the connector clamp socket comprising:
a plug contact receptacle and at least one insertion opening;
wherein the plug contact receptacle is configured to receive a plug contact which penetrates through the insertion opening into the plug contact receptacle along an insertion direction;
wherein a cross-section of the connector clamp socket has an irregular, at least sectionally concave polygonal shape with at least five apexes; and
wherein the cross-section has two long sides that are opposite one another with respect to the plug contact receptacle.

2. The connector clamp socket according to claim 1, wherein the two long sides run parallel to each other and to the insertion direction.

3. The connector clamp socket according to claim 1, wherein the insertion opening extends perpendicular to at least one of the long sides.

4. The connector clamp socket according to claim 1, wherein an apex of the concave section of the polygonal cross-section is located opposite the insertion opening in the insertion direction.

5. The connector clamp socket according to claim 1, wherein the insertion opening extends perpendicular or parallel to the polygonal cross-section.

6. The connector clamp socket according to claim 1, wherein the assembly direction runs perpendicular to the polygonal cross-section.

7. The connector clamp socket according to claim 1, wherein the connector clamp socket has a total of two insertion openings.

8. The connector clamp socket according to claim 1, wherein the connector clamp socket has a section extending in the assembly direction and having the polygonal cross-section.

9. The connector clamp socket according to claim 1, wherein the connector clamp socket is configured as a stamped and bent part made from a sheet metal, wherein the stamped and bent part is bent around the plug contact receptacle and has an overlap on one of the long sides of the polygonal cross-section.

10. The connector clamp socket according to claim 1, wherein the polygonal cross-section is pentagonal.

11. The connector clamp socket according to claim 1,
wherein the connector clamp socket has a lamella insertion opening; and
wherein the plug contact receptacle is configured to receive both a contact lamella extending through the lamella insertion opening into the plug contact receptacle and a plug contact extending through the insertion opening into the plug contact receptacle.

12. An arrangement comprising an electrical component and a connector clamp socket according to claim 1,
wherein the electrical component has a contact lamella; and
wherein the connector clamp socket is attached to the contact lamella;
wherein the electrical contact lamella extends into the flat contact receptacle of the connector clamp socket.

13. An electric connection with a connector clamp arrangement according to claim 1 with a flat plug contact inserted into the connector clamp socket in the insertion direction.

14. An electric connection with an arrangement according to claim 12 with a flat plug contact inserted into the connector clamp socket in the insertion direction.

15. The electric connection according to claim 14, wherein an end of the flat plug contact pointing in the insertion direction is, with respect to the insertion direction, located behind an end of a long side, the end of the long side pointing in the insertion direction.

16. The electric connection according to claim 14, wherein a center plane of the flat plug contact, the center plane being located halfway through the material thickness of the flat plug contact, and an apex of the polygonal cross-section lie opposite one another at the same height.
